(19) United States
(12) Patent Application Publication
(10) Pub. No.: US 2017/0205579 A1
(43) Pub. Date: Jul. 20, 2017

(54) ENCLOSURE FOR MODIFIED OPTICAL FIBER

(71) Applicant: Coherent, Inc., Santa Clara, CA (US)

(72) Inventors: Douglas W. ANTHON, El Cerrito, CA (US); Jay Michael INGALLS, Folsom, CA (US)

(21) Appl. No.: 14/996,079

(22) Filed: Jan. 14, 2016

(51) Int. Cl. G02B 6/14; G02B 6/255; G02B 6/02

(52) U.S. Cl. CPC G02B 6/14; G02B 6/02395; G02B 6/2558

(57) ABSTRACT

A mode-stripper for an optical fiber includes a water-cooled enclosure. A portion of an optical fiber to be mode-stripped is modified in a way which allows radiation to leak from cladding of the fiber. The optical fiber extends through the enclosure from a proximal end thereof to a distal end thereof, with the modified portion of the fiber within the enclosure. The fiber is fixedly held in the enclosure at the proximal end thereof and held at the distal end of the enclosure by an elastomeric diaphragm.

### TECHNICAL FIELD OF THE INVENTION

The present invention relates in general to optical fibers carrying high-power laser-radiation. The invention relates in particular to such optical fibers which have been spliced, or have been otherwise modified to allow laser-radiation to escape from cladding of the optical fibers.

### DISCUSSION OF BACKGROUND ART

Optical fibers used to generate or transport high power optical radiation, for example radiation having a power of about one to several kilowatts (kW), often have a dual waveguide structure, with an inner “core” waveguide defined by the glass refractive index profile near the center of the fiber and an outer “cladding” waveguide, which is defined by the glass and polymer refractive-index profile near an outer edge of the fiber. Even when most of the power is carried by the core waveguide, there can still be significant optical power of radiation in the cladding waveguide. The cladding radiation may be optical pump-radiation used to energize an active optical fiber, or higher-order unwanted modes of generated radiation. In any event, it is usually necessary to remove this cladding-mode radiation from the fiber before it reaches a point of use, or a point where it can burn some other component in a system in which the fiber is utilized.

Devices used for removing high-power cladding-mode radiation are usually referred to by practitioners of the art as “mode-strippers”. Mode-stripping is typically effected by removing a protective polymer coating from a section of the fiber, and then modifying that section to reduce the optical waveguide efficiency so the cladding radiation escapes from the fiber. One such modification means is etching the cladding surface so that power is coupled out of the cladding by scattering. Another such modification means is reducing the diameter of the cladding at a predetermined location without reducing the diameter of the core. Such modification is achieved by splicing together two fibers with different outer diameters. This is commonly referred to by practitioners of the art as a down-splice. The annular cross section of the larger fiber that does not overlap the smaller fiber at this “down-splice” acts as a window to couple cladding light out of the fiber.

Eliminating the protective polymer layer in the modified section allows such modified fibers to withstand high optical powers, but leaves the modified fibers more fragile than unmodified fibers, and in need of protection from environmental contamination. Such protection is typically provided by an enclosure for the modified portion of the fiber. When the modified portions of such fibers are mounted in a protective enclosure, the enclosure must also absorb and dissipate the “stripped” radiation. Such an enclosure may be sealed to minimize environmental contamination, and may be fluid-cooled if the power of stripped radiation is sufficiently high.

A problem frequently encountered with such mode-strippers is that the portion of fiber within the enclosure can be damaged or broken by mechanical stresses imposed on the fiber by differential thermal expansion between the fiber and the enclosure. There is a need for a mode-stripper arrangement that can reduce such stresses to benign levels for reducing, if not altogether eliminating, fiber breakage.

### SUMMARY OF THE INVENTION

In one aspect, optical apparatus in accordance with the present invention comprises an enclosure having first and second ends. An optical fiber having a core and cladding extends through the enclosure from the first end thereof to the second end thereof. The optical fiber has a modified portion thereof within the enclosure. The optical fiber is fixedly attached to the enclosure at the first end thereof, and attached to the enclosure at the second end thereof by a flexible diaphragm.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain principles of the present invention.

FIG. 1 is a three-dimensional view schematically illustrating a preferred embodiment of a mode-stripper in accordance with the present invention, including an enclosure having a radiation-absorbing base and a cover, and an optical fiber extending through the enclosure from a proximal end thereof to a distal end thereof.

FIG. 1A is a three-dimensional view schematically illustrating the mode-stripper of FIG. 1 with the cover removed to reveal details of the base, and details of the optical fiber and a flexible membrane for attaching the optical fiber to a distal end of the enclosure.

FIG. 1B is an enlarged, fragmentary, three-dimensional view schematically illustrating further detail of the distal end of the enclosure-base, the membrane, and the optical fiber of FIG. 1A.

FIG. 1C is a three-dimensional view schematically illustrating the base of FIG. 1A with the optical fiber removed.

FIG. 1D is a three dimensional view schematically illustrating the optical fiber of FIGS. 1, 1A, and 1B outside of the enclosure.

FIG. 2 is a three-dimensional view schematically illustrating a preferred embodiment of a splice-holder in accordance with the present invention including an enclosure having a radiation absorbing base and a cover, and an optical fiber extending through the enclosure from a proximal end thereof to a distal end thereof.

FIG. 2A is a three-dimensional view schematically illustrating the splice-holder of FIG. 2 with the cover removed to reveal details of the base, and details of the optical fiber and a flexible membrane for attaching the optic fiber to the distal end of the enclosure.

FIG. 2B is a three-dimensional view schematically illustrating details of the cover of the enclosure of the splice-holder of FIG. 2 including gaskets for sealing the cover to the base of the enclosure.

### DETAILED DESCRIPTION OF THE INVENTION

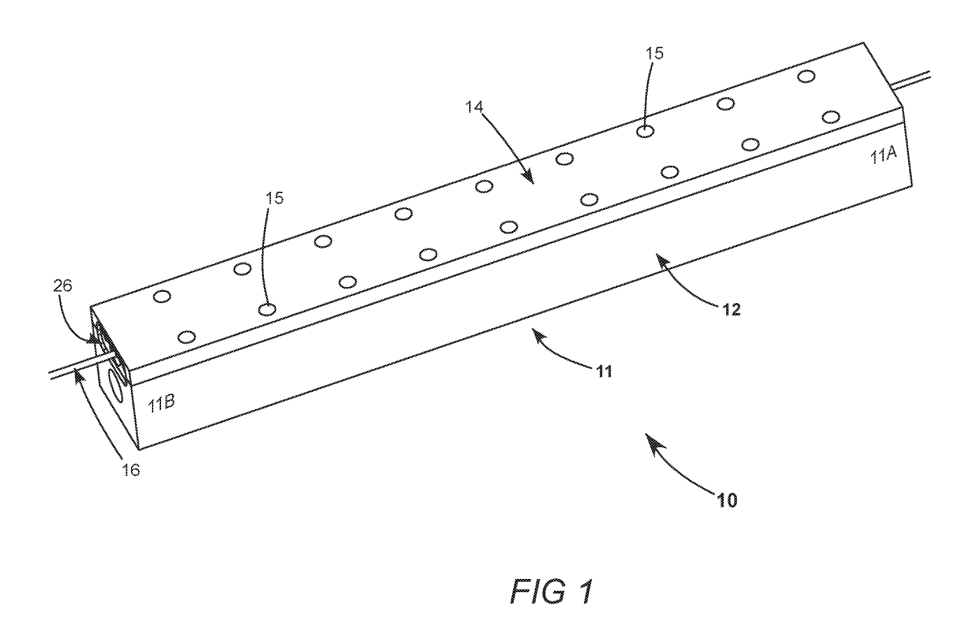

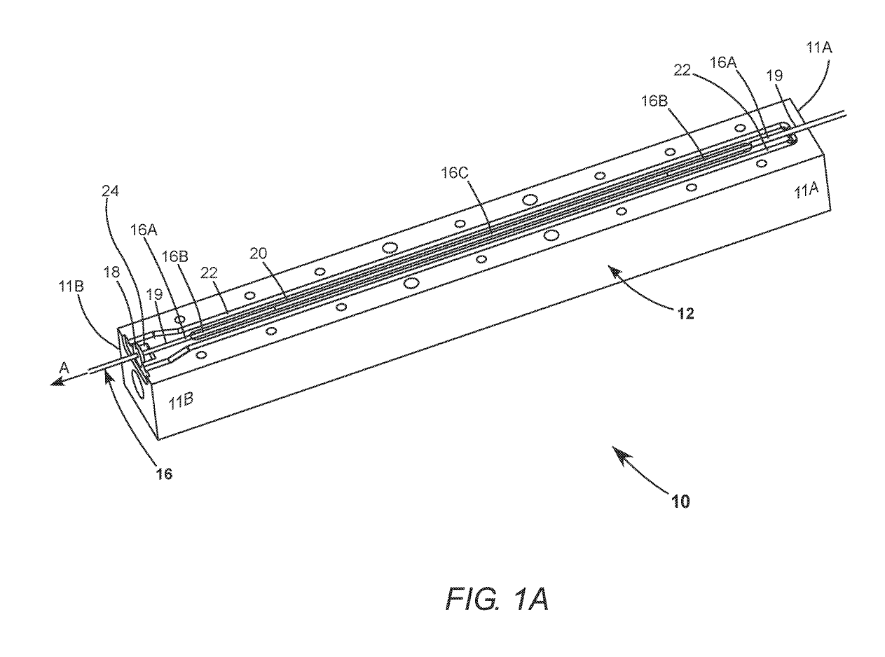

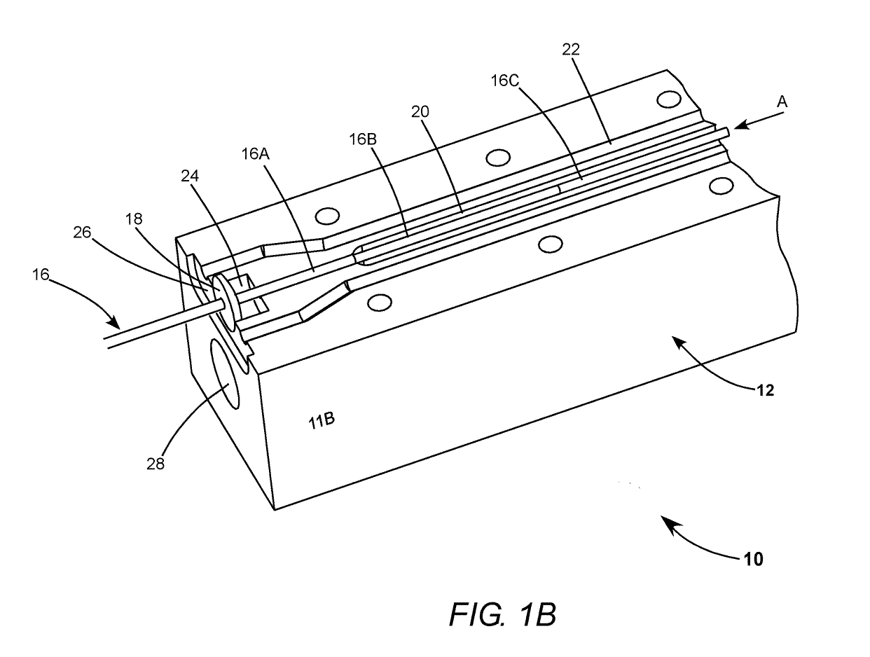

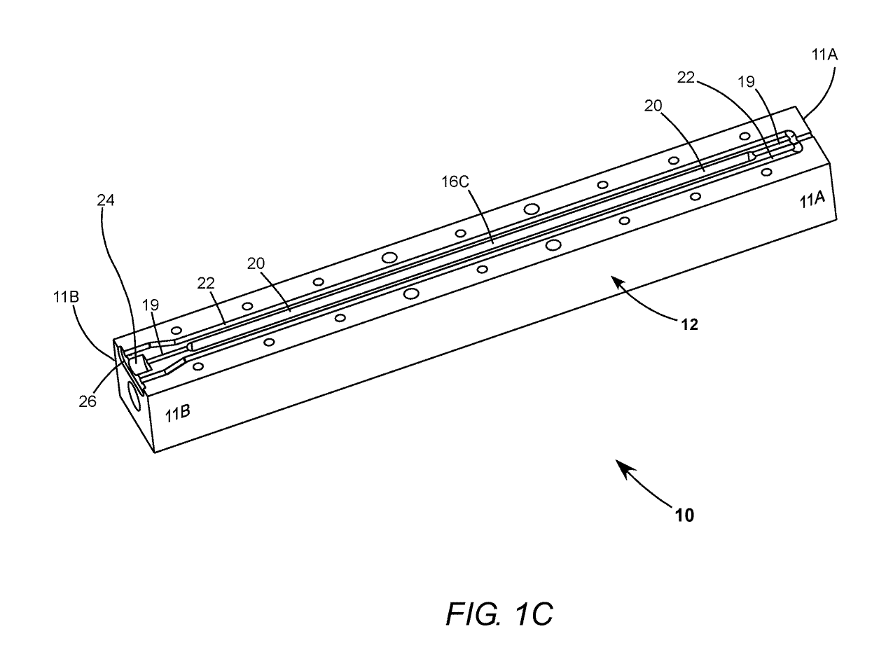

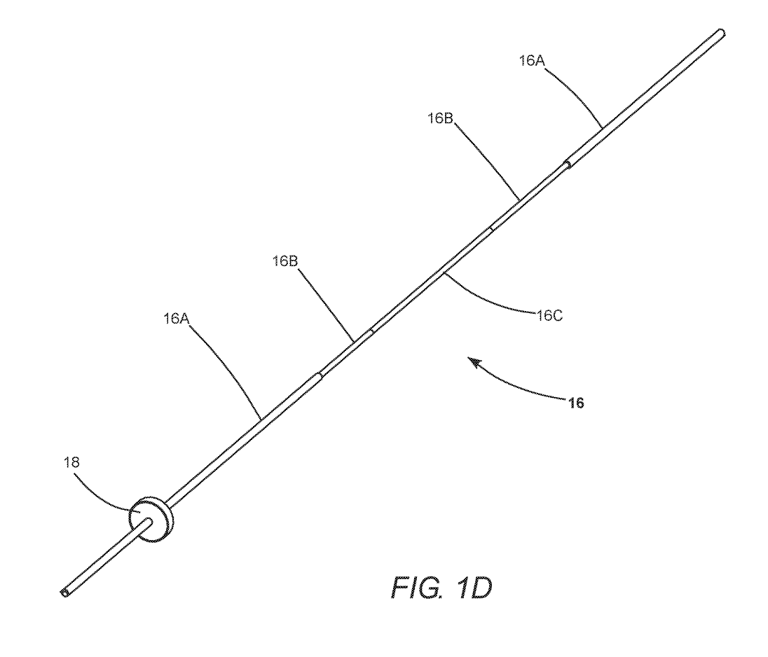

Turning now to the drawings, wherein like features are designated by like reference numerals, FIG. 1 schematically illustrates a preferred embodiment 10 of a mode-stripper in accordance with the present invention. Mode-stripper 10 includes an enclosure 11 having a radiation-absorbing base 12 and a cover 14. Cover 14 is attached to base 12 by screws 15. An optical fiber 16, from which cladding modes are to be stripped, extends through the enclosure from a proximal end 11A thereof, to a distal end 11B thereof. There is a recess 26 in end 11B of the enclosure, formed by corresponding recesses in the base and the cover. The purpose of this recess is explained further hereinbelow.

Base 12 and cover 14 are preferably made from a material having a high thermal conductivity. A metal is preferred, for ease of machining. One suitable metal is copper (Cu). A ceramic material such as aluminum nitride (AlN) may be used. This has a closer coefficient of thermal-expansion-match to fiber 16 than has copper, but may present difficulty in machining required complex shapes therein.

FIG. 1A schematically illustrates mode-stripper 10 of FIG. 1 with the cover removed to reveal details of base 12, and details of optical fiber 16 and a flexible membrane 18 for attaching the optical fiber to distal end 11B of the enclosure. A preferred propagation direction of radiation through the optical fiber for this embodiment of the present invention is indicated by arrow A.

FIG. 1B is an enlarged view of base 12 at distal end 11B of the enclosure. FIG. 1C schematically illustrates the base of FIG. 1A with optical fiber 16 removed. FIG. 1D schematically illustrates optical fiber 16 before installation in the enclosure.

Referring in particular to FIG. 1D, optical fiber 16, in portions 16A thereof, is covered by a protective polymer-coating. The protective polymer-coating is stripped from the coating to expose the cladding in portions 16B and 16C of the optical fiber. In portion 16C, the exposed cladding is modified, by etching, to provide a mode-stripping function.

A flexible membrane 18 is attached to a protective-coated portion 16A of the fiber. The flexible membrane is preferably formed from an elastomer, such as a silicone elastomer. One suitable silicone elastomer is RTV615, which is commercially available from a number of suppliers. RTV615 is a clear liquid, which cures at room-temperature to high strength silicone rubber (elastomer) with the addition of curing-agents. The RTV615 is supplied with curing-agent in matched kits, which are designed for use at a convenient 10:1 ratio by weight.

The membrane may be pre-formed, then slipped onto the fiber, and attached to the fiber, using a silicone adhesive, at a predetermined point on a coated portion 16A thereof. Alternatively, the membrane may be molded onto the coated portion of the fiber, using a suitable mold.

Regarding dimensions of the membrane, a preferred thickness of a RTV615 silicone membrane is 1.0 millimeter (mm), and a preferred diameter is between about 2 mm and about 6 mm. By way of example, a thickness of 1.0 mm and a diameter of 4 mm will allow optical fiber 16 to travel about 100 micrometers (μm) with a stress of less than 1.0 Newton (N) imposed thereon. A force of 1 N results in a stress of 1.27 Megapascal (MPa) on a 500 μm-diameter fiber. This is about 1.8% of the typical proof-stress of such a fiber. If aluminum nitride is used to form base 12 and cover 14, membrane 18 may have a diameter as small as 1 mm, and produce the same result.

Continuing now with reference to FIGS. 1A-C, base 12 has a slot 20 therein for receiving radiation stripped from cladding of portion 16C of optical fiber 16. The slot is preferably blackened, for example by anodizing, to absorb the stripped radiation. Base 12 is water-cooled to prevent overheating of the base by the stripped radiation. A water inlet 28 is provided in distal end 11B of the base (enclosure). There is a corresponding water outlet (not visible) at an opposite end of the base. A detailed description of the water cooling arrangement is not necessary for understanding principles of the present invention, and, accordingly, is not described or depicted herein. Those skilled in the art may use any suitable water cooling arrangement without departing from the sprit and scope of the present invention.

Surrounding slot 20 is channel 22, into which uncured elastomer may be injected to form a seal between base 12 and cover 14, after the mode-stripper is assembled. There is a groove 19 at each end of base 12 arranged to support optical fiber 16. The groove communicates with slot 20 and channel 22. There is a corresponding channel and groove (not visible) in cover 14 of FIG. 1.

In assembling the inventive mode-stripper, optical fiber 16 is placed on base 12 with coated portions 16A of the optical fiber seated in groove 19, at each end of the base. Membrane 18 on the optical fiber is accommodated in a semicircular recess 24 in base 12. There is a corresponding recess in cover 14. The membrane may be attached to the recess with a silicone adhesive or the like.

Once the fiber is seated correctly on base 12, cover 14 can be attached to base 12 by screws 15, as noted above, to form enclosure 11. When the cover is thus attached, liquid elastomer (with curing agent) is injected into channel 22. The liquid elastomer flows around channel 22, and, when cured, forms a seal between base 12 and cover 14. The elastomer also surrounds coated portion 16A of optical fiber 16 at proximal end 11A of enclosure.

When cured, the elastomer seals optical fiber 16 to the enclosure at end 11A thereof, providing a rigid or fixed attachment of that portion of the fiber to the enclosure. The terminology “rigid or fixed attachment”, as used in this description and the appended claims, means fixed to the extent that some minimal compliance may be offered by the elastomer seal. This seal should be kept as thin as practical to provide good thermal communication between the optical fiber and the enclosure.

At end 11B of the enclosure, the edge of membrane 18 on the optical fiber is attached to recess 24. A recess 26 in base 12, together with a corresponding recess in cover 14 (see FIG. 1) provides a trough which can be filled with elastomer to complete sealing of the membrane to the enclosure. The membrane thus provides for a compliant (flexible) attachment of the optical fiber to the enclosure at end 11B thereof. This allows for relative movement between the fiber and the enclosure due to differential thermal expansion or contraction of the optical fiber and the enclosure.

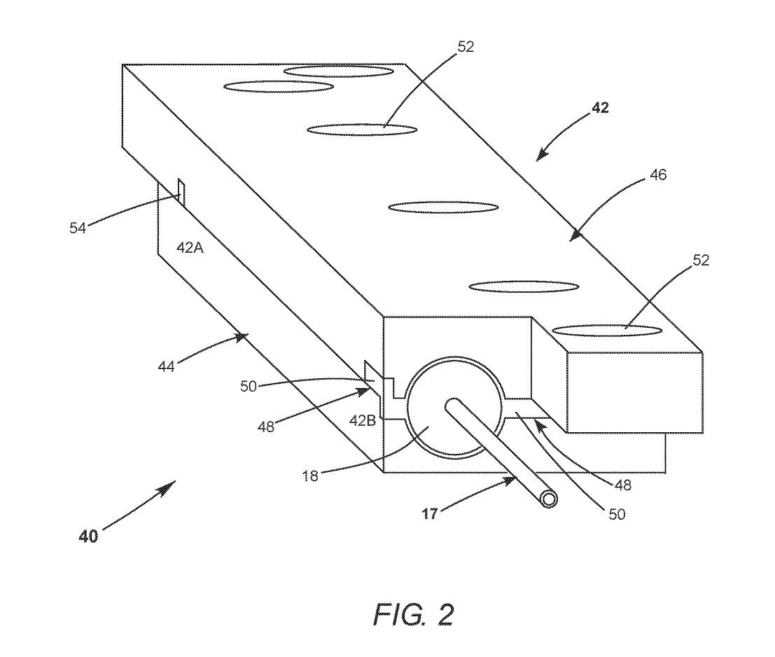

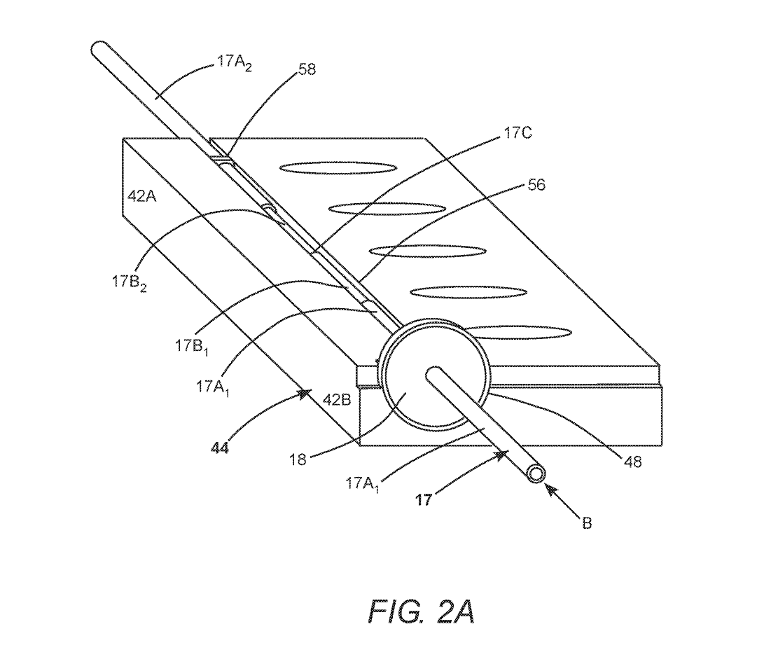

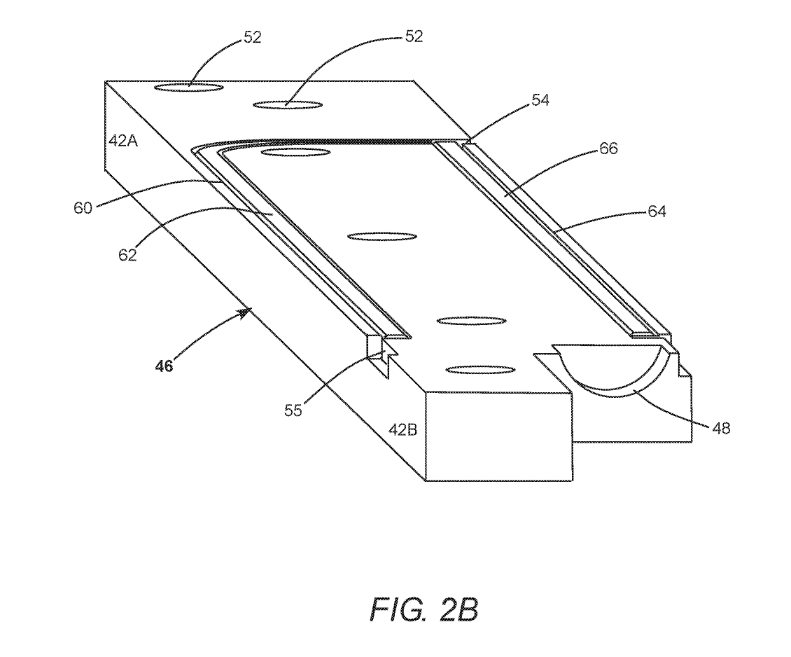

FIG. 2 schematically illustrates a preferred embodiment 40 of a splice-holder in accordance with the present invention. There are many similarities between mode-stripper 10 of FIG. 1 and splice-holder 40. The description of the splice-holder set forth below is appropriately limited to avoid duplicate description of similar features of the mode-stripper and the splice-holder.

Splice-holder 40 includes an enclosure 42, formed from a radiation-absorbing base 44 and a cover 46. A spliced optical fiber 17 extends through the enclosure from proximal end 42A thereof to distal end 42B thereof. The optical fiber has an inventive membrane 18 attached on a protective-coated portion 17A of the optical fiber The membrane is attached to the enclosure by elastomer 50 filling a recess 48 in the enclosure. The recess is formed by corresponding cut-outs in base 44 and cover 46. A port 54 provides for injection of liquid elastomer/curing-agent mixture for purposes described further hereinbelow. Water-cooling ports 52 are provided in cover 46. A detailed description of the water-cooling arrangements is not provided herein, for reasons noted above regarding water-cooling arrangements for mode-stripper 10.

FIG. 2A schematically illustrates the splice-holder of FIG. 2 with the cover removed to reveal details of base 44, and details of the attachment of optical fiber 17 to the enclosure. In this instance, optical fiber 17 is formed from two fiber-sections spliced to together. One fiber-section includes a coated portion 17A₁ and a “stripped” portion 17B₁. The other fiber-section includes a coated portion 17A₂ and a “stripped” portion 17B₂.

The cladding of stripped portion 17B₁ has a greater diameter than the cladding of stripped portion 17B₂. The core diameter is the same in both portions. The fiber sections are joined by a splice 17C between stripped portions 17B₁ and 17B₂. The spliced-together portions constitute a “modified” portion of fiber 17.

Base 44 has a channel 56 extending therethrough. The channel is deep enough and wide enough to accommodate protective-coated portions 17A₁ and 17A₂ of optical fiber 17. Optical fiber 17 is attached to channel 56 by an elastomer-bead 58 surrounding fiber portion 17A₂ at end 42A of the base of the enclosure. Membrane 18, attached to optical fiber 17, is attached to recess 48 of the enclosure. The modified portion of the fiber, including the splice, is within the enclosure, and supported, in accordance with the present invention, such that the integrity of the splice can be maintained over a range of temperature variations of the enclosure.

In this instance, the preferred propagation direction of radiation in optical fiber 17 is indicated by arrow B. A purpose of this particular modification of optical fiber 17 provides that radiation in the cladding of portion 17B₁ can escape from the cladding. The optical fiber and splice-holder are functioning as a mode-stripper. With radiation propagating in the indicated preferred propagation direction, the “escaped” or “stripped” radiation at the splice is directed away from membrane 18.

FIG. 2B schematically illustrates details of cover 46 of the enclosure 42, of splice-holder 40 of FIG. 2. Cover 46 includes a “hockey stick” shaped channel 60, which houses an elastomer gasket 62, and a straight channel 64, communicating with channel 60, which houses an elastomer gasket 66. Notch 54, discussed above, and a similar notch 55, provide for injection of curable liquid-elastomer into channels 60 and 64 to complete the integrity of the seal between cover 46 and base 44 provided by the gaskets.

In summary, the present invention is described above with reference to two preferred embodiments. The invention is not limited, however, to the embodiments described and depicted herein. Rather the invention is limited only by the claims appended hereto.

1. Optical apparatus, comprising:
an enclosure having first and second ends;
an optical fiber having a core and cladding, and extending through the enclosure from the first end thereof to the second end thereof, the optical fiber having a modified portion thereof within the enclosure; and
wherein the optical fiber is fixedly attached to the enclosure at the first end thereof, and attached to the enclosure at the second end thereof by a flexible diaphragm wherein the diameter of the diaphragm is between two and six times the thickness of the diaphragm to permit relative movement between the optical fiber and the enclosure.

2. The apparatus of claim 1, wherein the modified section is an etched section.

3. The apparatus of claim 2, wherein radiation carried by the fiber propagates through the fiber from the first end of the enclosure to the second end of the enclosure.

4. The apparatus of claim 1, where the modified portion of the optical fiber includes first and second fiber-portions spliced together.

5. The apparatus of claim 4, wherein the first fiber-portion has cladding of a larger diameter than that of the second fiber-portion.

6. The apparatus of claim 5, wherein the first fiber-portion is closer to the flexible diaphragm than the second fiber-portion, and wherein radiation carried by the fiber propagates through the fiber from the second end of the enclosure to the first end of the enclosure.

7. The apparatus of claim 1, wherein the optical fiber has a protective polymer coating thereon except on the modified portion thereof.

8. The apparatus of claim 7 wherein the flexible diaphragm is attached to the optical fiber on a protective coated portion thereof, and the protective coating is on the optical fiber where the optical fiber is attached to the first end of the enclosure.

9. The apparatus of claim 1, wherein the flexible diaphragm is formed from an elastomer.

10. The apparatus of claim 9, wherein the elastomer is a silicone elastomer.

11. Optical apparatus, comprising:
an enclosure having first and second ends;
an optical fiber having a core and cladding, and extending through the enclosure from the first end thereof to the second end thereof, the optical fiber having an etched section thereof within the enclosure; and
wherein the optical fiber is fixedly attached to the enclosure at the first end thereof, and attached to the enclosure at the second end thereof by a flexible diaphragm formed from an elastomer and wherein the diameter of the diaphragm is between two and six times the thickness of the diaphragm to permit relative movement between the optical fiber and the enclosure.

12. The apparatus of claim 11, wherein radiation carried by the fiber propagates through the fiber from the first end of the enclosure to the second end of the enclosure.

13. The apparatus of claim 11, wherein the elastomer is a silicone elastomer.

14. The apparatus of claim 11, wherein the optical fiber has a protective polymer coating thereon except on the etched portion thereof and wherein the flexible diaphragm is attached to the optical fiber on a protective coated portion thereof, and the protective coating is on the optical fiber where the optical fiber is attached to the first end of the enclosure.

15. Optical apparatus, comprising:
an enclosure having first and second ends;
an optical fiber having a core and cladding, and extending through the enclosure from the first end thereof to the second end thereof, the optical fiber having a modified portion thereof within the enclosure, the modified portion including first and second fiber-portions spliced together; and
wherein the optical fiber is fixedly attached to the enclosure at the first end thereof, and attached to the enclosure at the second end thereof by a flexible diaphragm formed from an elastomer and wherein the diameter of the diaphragm is between two and six times the thickness of the diaphragm to permit relative movement between the optical fiber and the enclosure.

16. The apparatus of claim 15, wherein the first fiber-portion has cladding of a larger diameter than that of the second fiber-portion.

17. The apparatus of claim 16, wherein the first fiber-portion is closer to the flexible diaphragm than the second fiber-portion, and wherein radiation carried by the fiber propagates through the fiber from the second end of the enclosure to the first end of the enclosure.

18. The apparatus of claim 17, wherein the elastomer is a silicone elastomer.
